(19) United States
(12) Patent Application Publication
(10) Pub. No.: US 2005/0243450 A1
(43) Pub. Date: Nov. 3, 2005

(54) Exterior mirror assembly with permanent attachment

(76) Inventors: Heinrich Lang, Ergersheim (DE); Jochen Denkfelder, Gunzenhausen (DE); Albrecht Popp, Weihenzell (DE); Jorg Scholler, Ergersheim (DE)

Correspondence Address: MCNAIR LAW FIRM, PA, P.O. BOX 10827, GREENVILLE, SC, 29603-0827, US

(21) Appl. No.: 11/119,626

(22) Filed: May 2, 2005

(30) Foreign Application Priority Data
May 3, 2004 (DE) 102004021582.0

(51) Int. Cl. G02B 7/182

(52) U.S. Cl. 359/879; 359/871

(57) ABSTRACT

The invention is a mirror arrangement for commercial vehicles. The mirror arrangement comprises a mirror foot adapted for permanent attachment to an associated commercial vehicle and a mirror head attached to the mirror foot. The mirror head comprises a housing, a mirror pane carried by the housing for providing a view of the area behind the mirror arrangement, and a connector disposed between the mirror foot and the mirror head for connecting the mirror foot to the mirror head. The mirror foot comprises a support arm disposed between the connector and an associated vehicle for providing support to the mirror arrangement. The mirror foot also comprises a mounting bracket adapted for permanent attachment to an associated vehicle.

### CROSS REFERENCE TO RELATED APPLICATION

Applicant claims priority on pending U.S. application Ser. No. 10/053,830, filed on Jan. 22, 2002, which is a continuation of U.S. application Ser. No. 09/304,001, filed on Apr. 30, 1999, now U.S. Pat. No. 6,554,436 B1 incorporated by reference.

### FIELD OF THE INVENTION

The present invention relates to a mirror arrangement for commercial vehicles, in particular for large trucks.

### BACKGROUND OF THE INVENTION

Commercial vehicles such as busses and trucks are equipped with mirror arrangements, giving those inside the vehicle a view of the surroundings behind or next to the vehicle. Normally, for this purpose, a mirror head having a mirror pane and housing is attached to the body of the vehicle via a mirror foot. The attachment is routinely accomplished by means of a mount affixed to the vehicle by screws or similar fasteners in a detachable manner.

The detachable attachment is necessary because the mirror arrangement is produced externally as a semi-finished product and so the product can be purchased separately. Furthermore, the detachable attachment allows for easy replacement of a damaged mirror arrangement or a change to different mirror heads, e.g. to a mirror pane that is adjustable by motorized means.

In the case of buses, “horn-shaped” mirrors are being used more. In a horn mirror, the mirror foot extends forward essentially in the direction of travel from a forward upper corner of the vehicle body. The mirror foot is also inclined to the side and/or down if necessary. These “horn” mirrors are more aerodynamic than conventional mirror arrangements, allow for a better geometric and optical positioning of the mirror pane, and reduce the lateral overall width of the bus. With these “horn” mirrors the mirror foot is also attached to the vehicle body in a detachable manner.

For a mirror arrangement according to the present state of the art, the connection between the mirror foot and the vehicle body must be detachable in order to make replacement possible. However, this connection bears the entire weight of the mirror arrangement. Since the vibrations of the vehicle body are transmitted to the connection, which consists generally of screws, the danger exists that the connection may loosen and detach.

Especially for this reason, the horn mirrors described above are not being used with trucks operating under rough environmental conditions, e.g. on building sites and subjected to frequent impact loads.

### SUMMARY OF THE INVENTION

The above problems are overcome by the present invention by providing a mirror support mount permanently affixed to a frame element at an overhead portion of a vehicle cab.

A generally L-shaped mirror housing carried by the mirror base member comprises a mirror pane carried by the mirror housing for providing a view of the area behind the mirror arrangement, a support arm disposed between the mirror housing and the vehicle for providing support to the mirror arrangement, and a connector coupling disposed between the mirror base member and the mirror housing for connecting the mirror base member to the mirror. Further, a moveable joint disposed between the connector coupling and the support arm allows the mirror head to move relative to the connector coupling.

The support arm is an elongate support arm extending generally horizontal from the vehicle. The mirror base member further comprises a sheathing for enclosing the support arm. The mirror pane is adjustably attached to the mirror housing.

The horn shaped mirror arrangement for commercial vehicles comprises a mirror support mount adapted for permanent attachment to an associated commercial vehicle, and thus, is made integral with the frame of the commercial vehicle. The mirror housing is operatively associated with the mirror support mount and a connector coupling disposed between the mirror base member and the mirror housing for connecting the mirror foot to the mirror head.

Further, the mirror arrangement comprises a support arm disposed between the connector coupling and the mounting bracket for providing support to the mirror arrangement. The elongate support arm, enclosed by a sheathing, extend essentially horizontally from the vehicle. A moveable joint disposed between the connector coupling and the support arm allows the mirror head to move relative to the vehicle. Further the mirror housing comprises a mirror pane carried by the housing for providing a view of the area behind the mirror arrangement. The mirror pane is adjustably attached to the mirror housing.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a side elevation of a commercial vehicle having a mirror assembly according to the present invention;

FIG. 2 is a perspective view of the mirror arrangement of FIG. 1 with parts separated;

FIG. 3 is a perspective view of an enlarged detail of a part of FIG. 2; and

FIG. 4 is a perspective view of an enlarged detail of FIG. 3.

### DETAILED DESCRIPTION OF AN ILLUSTRATED EMBODIMENT

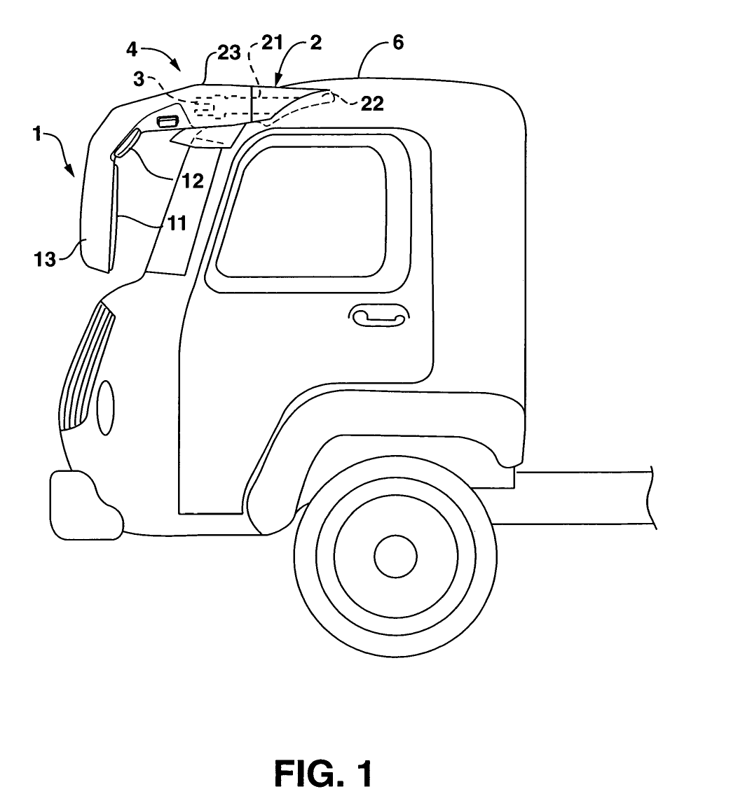

As can best be seen in FIG. 1, an exterior mirror assembly, according to the illustrated embodiment of the invention, includes a mirror head, shown generally as 1, and a mirror foot, shown generally as 2, which provides a mirror base. Mirror foot 2 is permanently attached to an upper portion 4 of cab 6 of the commercial vehicle through an integral support mount, illustrated in the form of a mounting bracket 22. The bracket may be a plate or other suitable form of attachment. This permanent attachment provides for greater stability for the exterior mirror assembly. Further, the exterior mirror assembly is of the horn mirror form attached to an upper portion 6 of the cab that allows the greatest amount of viewing for the operator of a commercial vehicle. Horn mirrors are advantageous for the range of view they provide, but traditionally do not provide the stability necessary for commercial vehicles. The integral attachment of mirror foot 2 to the commercial vehicle through mounting plate 22 provides integral and greater stability. The integral attachment may be made by welding at 8, by lamination or adherence, or any other suitable means which is generally permanent, as opposed to screws and other forms of non-permanent attachment. Further, a support arm 21 is included within mirror foot 2 to provide additional support. The mirror housing 1, contains two mirror panes. Main mirror 11 provides the operator of the commercial vehicle with a view of the items to the rear of the commercial vehicle. Wide-angle mirror 12 provides the operator of the commercial vehicle with a wide-angle view of items of the periphery and rear of the commercial vehicle.

The mirror assembly as described above and shown in FIGS. 1 to 3 comprises mirror housing 1 with two mirror panes 11 and 12, the main mirror and the wide-angle mirror, respectively, which preferably are located in a housing 1 so as to be adjustable by an associated motor. In this manner, the mirror pane may be adjusted. In certain embodiments, a motor may be provided to position the mirror pane in any desired position.

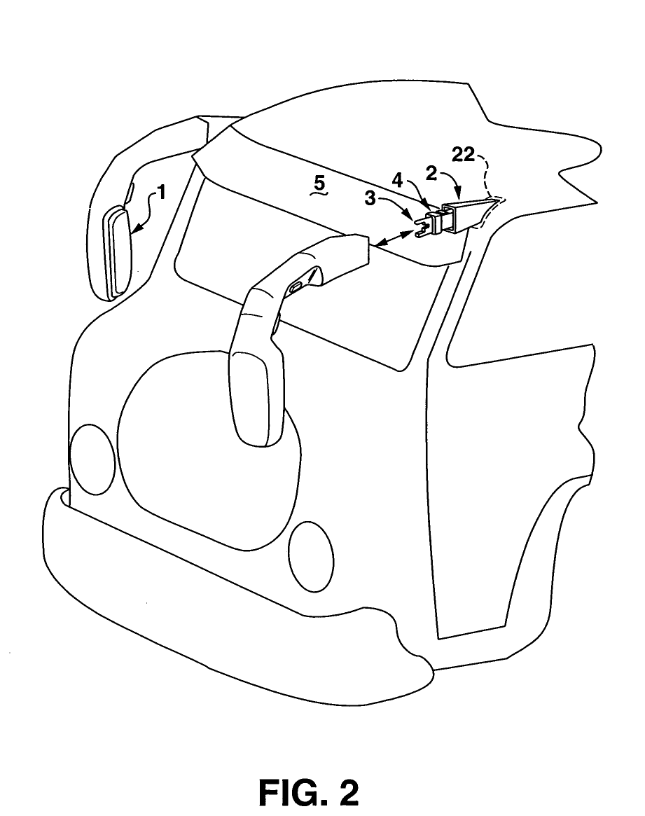

Referring now to FIG. 2, an exploded view of the exterior mirror assembly is shown in a perspective view. As is shown, mirror housing 1 is not attached directly to mirror foot 2 which is permanently attached via mounting bracket 22 to a frame member 24 of the commercial vehicle. For this purpose, a connector coupling 3 is carried on support arm 21 as a part of mirror foot 2. Connector coupling 3 is designed to attach mirror head 1 in a manner that allows stable attachment and easy removal of the mirror head. Due to the ability to detach the mirror head, repairs are able to be made in a cheaper fashion, and updated mirror assemblies may be included in commercial vehicles.

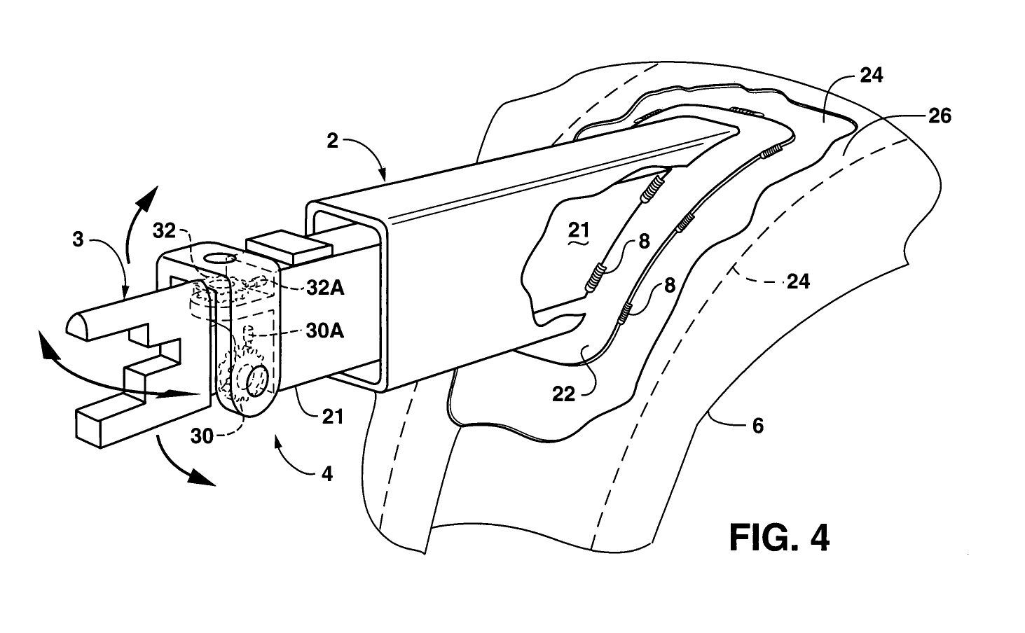

As can best be seen in FIG. 4, connector coupling 3 is carried by a rotary connector joint 4 affixed to support arm 21 and, hence, to mounting bracket 22. The moveable joint 4 includes two hinges 30 and 32 with multiple stop points. Detents 32a proves the stops The moveable joint 4 allows the mirror head 1 to collapse upon impact. This prevents damage should the operator of the commercial vehicle strike an obstacle with the exterior mirror arrangement. The moveable joint 4 may also be located forward of the connector coupling 3. The moveable joint clicks in and can be rotated around a pivot axis so that a pre-positioning of the mirror head in certain basic positions is possible, with the precise adjustment of the field of vision being then obtained by adjusting the mirror pane 11, 12 in the housing 13. The moveable joint also ensures a deflection of the mirror head in case of collision with an obstacle and makes it possible for the mirror head to fold into a transport position tight against the vehicle. The moveable joint may comprise a hinge with predetermined stop positions. This form of a joint allows the mirror head to collapse upon impact and remain in that collapsed position until physically moved from that position. As the mirror head collapses inward after a predetermined distance, the mirror head would pass a certain stop point. This stop point would be a section of the hinge that would prevent the mirror head from snapping back into its previous position. A plurality of stops may be used in order to offer a plurality of positions in which the mirror head is allowed to collapse.

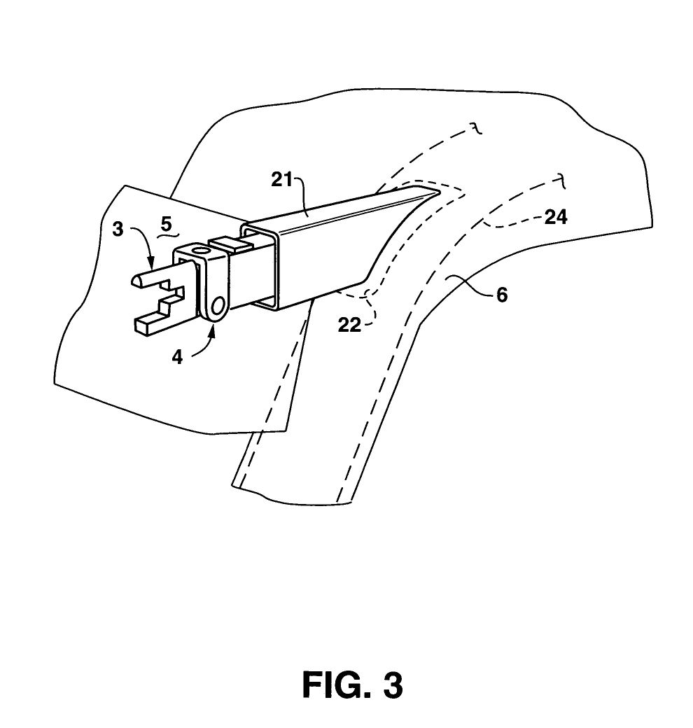

Referring now to FIG. 3, a detailed view of the mirror foot is shown. As is shown, mounting bracket 22 is made integral (or one-piece) with the commercial vehicle. This permanent, integral attachment may be achieved in a variety of ways, including but not limited to, welding the mounting bracket to an overhead frame structure 24 of the commercial vehicle, or laminating or adhering the mounting bracket to the frame or other structural part of the commercial vehicle. Base support arm 21 extends horizontally from mounting bracket 22. In addition, the mirror arrangement may comprise a sheathing 23 designed so that when installed it encloses the housing 13 of the mirror head 1. The support in the embodiment shown here may be made of metal and may be welded to the frame structure, such as an A-frame, of the body of the truck. In addition, the mirror foot 2, including base support arm 21 and mounting bracket 22, may be integral with the vehicle in that the support is integral with the mounting bracket and the sheathing 23 of the mirror foot is bonded to the body sheathing of the vehicle. The vehicle body 26 may cover the mounting bracket, at least the welds of the attachment.

The mirror foot, in further embodiments, may comprise a support, in particular made of metal and/or synthetic material, to increase the stability. A sheathing may also be included such that it may enclose the housing of the mirror head. As a result the mirror foot can be both very stable in its design, and be made with any desired shape, in particular with aerodynamically favorable outer contour.

When installed, the mirror foot extends essentially forward in the direction of travel, generally horizontal. The mirror foot is connected to the commercial vehicle in a non-detachable manner. The increased stability makes it now possible to use horn mirrors with trucks. This support member is able to provide support to the exterior mirror arrangement due to its permanent attachment. The rotary joint coupling discussed above is shown generally as 4, between connector coupling 3 and support arm 21.

Connector coupling 3 may be provided between the mirror head 1 and the mirror foot 2. This connector coupling can include, as can best be seen schematically in FIG. 3, two prongs 3a on the side of the mirror foot that engage corresponding recesses on the side of the mirror head and can be attached with the latter, such as by screws, for example. In an alternative embodiment, the connector coupling may be made in the form of a plug-in connection where the two prongs reach behind corresponding rear separations in the mirror head, in an interlocking manner, and snap in elastically in such manner that the mirror head and the mirror foot are attached to each other in a detachable manner.

Connector coupling 3 makes it possible, in addition to the stable attachment to the commercial vehicle, to replace a damaged mirror head easily. Since the mirror head projects the furthest from the vehicle, it is replaced most frequently. A replacement may be needed in case of retrofitting. For example, when switching from manually adjustable to motorized mirror panes. It is nevertheless still possible to manufacture the mirror arrangement externally and to purchase it in addition, since the expensive mirror head with mirror pane, adjusting devices, etc., can easily be installed afterwards by means of the connector coupling. In addition, a mirror foot suitable for a plurality of possible mirror heads may be provided such that when manufacturing the commercial vehicle, it may be integrated into the commercial vehicle.

All suitable known devices can be used as the connection device, in particular, screw connections, bayonet locks, plug-in connections etc. Since these connection devices do not support the weight of the entire mirror arrangement, but only the mirror head, less stability is required than for conventional attachments of the entire mirror arrangement to the commercial vehicle.

As can be seen best in FIG. 2, a sun shade 5 such as is used normally with trucks, together with the mounting bracket 22 may be laminated into the sheathing of the A-frame member 24. This arrangement enlarges the bearing surface of the bearing plate and also provides additional attachment of the sun shade.

While an embodiment of the invention has been described using specific terms, such description is for illustrative purposes only, and it is to be understood that changes in variations may be made without departing from the spirit or scope of the following claims.

1. A commercial vehicle and a mirror assembly comprising:
(a) a commercial vehicle having a front cab with an overhead frame structure near an upper portion of said cab;
(b) an integral support mount integral with said frame structure to provide an integral mirror and mounting structure;
(c) a generally L-shaped mirror having a mirror foot integral with said integral support mount to provide a mirror mounting structure integral with said vehicle;
(d) a mirror head carried by said mirror foot having a mirror pane providing a view of the rear area of the vehicle; and
(e) a detachable connector coupling connecting said mirror head and said mirror foot so that said mirror head may be removed from said mirror foot and replaced.

2. The apparatus of claim 1 including a moveable joint disposed between said connector coupling and said mirror foot for allowing said mirror head to move relative to said mirror foot.

3. The apparatus of claim 2 wherein said mirror foot includes an outer cover and an inner support arm carried within the housing extending generally horizontal from said vehicle, and said support arm having a first end integral with said support mount and a second end which carries said connector coupling.

4. The apparatus of claim 1 wherein said support mount includes a mounting plate, and said mirror foot includes a reinforcing support arm integral with said mounting plate to provide said integral mirror mounting structure.

5. The apparatus of claim 1 wherein said mirror foot extends generally horizontal from the vehicle and said mirror head depends from said mirror foot for viewing by said driver.

6. The apparatus of claim 1 wherein said connector coupling includes a first connector part carried by said mirror foot and second connector part carried by said mirror head, and said first and second connector parts being disconnectable so that said mirror head may be removed and replaced.

7. The apparatus of claim 1 wherein said moveable joint provides for movement about two axes of rotation so that said mirror can be adjusted for viewing and can be deflected upon accidental impact to reduce damage.

8. A horn shaped mirror arrangement for commercial vehicles having a cab with an overhead frame structure and outer vehicle body comprising:
an integral mirror support mount including a mounting plate integral with said overhead frame structure, said mounting plate being at least partially covered by the outer vehicle body;
a mirror foot integral with said mirror support mount to provide a mirror mounting structure integral with the vehicle;
a mirror head carried by said mirror support mount; and
a connector coupling disposed between said mirror foot and said mirror head for connecting said mirror foot mirror head together so that said mirror head can be replaced from said mirror foot integral with said vehicle body.

9. The mirror arrangement of claim 8 further comprises a support arm integral with said mounting plate for providing support to said mirror arrangement, and said connector coupling carried by said support.

10. The mirror arrangement of claim 9 wherein said support arm is an elongate support arm extending essentially horizontally from the vehicle.

11. The mirror arrangement of claim 10 wherein said mirror foot includes a sheathing for enclosing said support arm.

12. The mirror arrangement of claim 11 further comprising a moveable joint included in said connector coupling for allowing said mirror head to move relative to said mirror foot.

13. A method of mounting an exterior mirror arrangement on a vehicle having a cab with an overhead frame structure and an outer vehicle body comprising:
providing a generally L-shaped mirror assembly having a mirror foot and depending mirror head with a releasable connector between said mirror head and mirror foot;
providing a mounting plate integral with the overhead frame structure of the vehicle; wherein
at least a portion of the mounting plate is covered by a portion of the outer vehicle body;
integrally mounting said mirror foot to said mounting plate in a permanently fixed manner; whereby
an integral mounting structure is provided for mounting said mirror arrangement to the vehicle while the mirror head may be replaced in the event of damage.
